(19) United States
(12) Patent Application Publication
(10) Pub. No.: US 2015/0130963 A1
(43) Pub. Date: May 14, 2015

(54) IMAGE PROCESSING APPARATUS, IMAGE PROCESSING METHOD, AND COMPUTER PROGRAM

(71) Applicant: SONY CORPORATION, Tokyo (JP)

(72) Inventors: Kentaro Tanaka, Tokyo (JP); Kazuhiro Uchida, Kanagawa (JP); Masataka Suzuki, Tokyo (JP); Shunji Okada, Kanagawa (JP); Yoshitsugu Nomiyama, Kanagawa (JP); Naoya Katoh, Chiba (JP)

(73) Assignee: SONY CORPORATION, Tokyo (JP)

(21) Appl. No.: 14/401,965

(22) PCT Filed: Aug. 1, 2013
(86) PCT No.: PCT/JP2013/004674

§ 371 Date: Nov. 18, 2014

(30) Foreign Application Priority Data
Sep. 3, 2012 (JP) 2012-193350

(51) Int. Cl. H04N 5/232

(52) U.S. Cl. CPC H04N 5/23258; H04N 5/23267; H04N 5/23293
USPC 348/222.1

(57) ABSTRACT

An image processing apparatus includes an acquiring unit that acquires stability state information for an image capturing apparatus indicating whether the image capturing apparatus is stable or not, and a processor that rotates an image, captured by the image capturing apparatus, based on the stability state information of the image capturing apparatus.

### TECHNICAL FIELD

The present disclosure relates to an image processing apparatus, an image processing method, and a computer program.

The present disclosure contains subject matter related to that disclosed in Japanese Priority Patent Application JP 2012-193350 filed in the Japan Patent Office on Sep. 3, 2012, the entire content of which is hereby incorporated by reference.

### BACKGROUND ART

In place of silver halide cameras that pick up images using film or photographic plates, digital cameras that digitally encode images captured using an image sensor including a solid-state image pickup element such as a CCD (Charge Coupled Device) or a CMOS (Complementary Metal Oxide Semiconductor) have become widespread. By using a digital camera, there are the advantages that it is possible to store digitally encoded images in a memory and carry out image processing or image management on a computer. There is also the advantage that it is possible to avoid the problem of the limited lifespan of film.

Most digital cameras have an image processing function for correcting vibration (i.e., camera shake) in picked-up images produced during handheld photography by a photographer, and many technologies relating to vibration correction have been disclosed (see, for example, PTL 1). Also, to prevent images being picked up in a state where the subject is inclined to the horizontal direction due to camera shake or the like, a technology that corrects tilting of images so as to obtain picked-up images in which the horizontal is maintained has also been disclosed (see, for example, PTL 2).

### CITATION LIST

### Patent Literature

PTL 1: JP 2012-114682A

PTL 2: JP 2010-045733A

### SUMMARY

### Technical Problem

To pick up images in which there is no tilting from the outset, it is necessary to carry out fine adjustments using a level or the like to ensure that the images picked up by a digital camera are horizontal. If a level is not available, it is necessary to carry out adjustment using a horizontal line or a line on a building or the like so that the images picked up by a digital camera are horizontal. However, since the image size of the monitor provided on a digital camera is small, it is difficult for a photographer to notice slight tilting. Accordingly, there are cases where tilting will actually remain in the picked-up images even when the photographer has attempted to adjust the camera to the horizontal. Also, even slight amounts of tilting will be more prominent when picked-up images with tilting are displayed on a large display.

It is also possible to pick up images with no tilting by mounting a digital camera on a tripod and adjusting the tripod so that the images picked up by the digital camera are horizontal. However, if images with no tilting are picked up by adjusting a tripod, there is the task of mounting the digital camera on a tripod and adjustment to the horizontal is time-consuming, which means that photographers are not able to quickly start picking up images and there is an increased risk that photographic opportunities will be missed.

The present disclosure aims to provide a novel and improved image processing apparatus, image processing method, and computer program capable of correcting tilting of picked-up images in keeping with the state of a housing so that images in which tilting is corrected can be easily acquired.

### Solution to Problem

According to an embodiment of the present disclosure, there is provided an image processing apparatus includes an acquiring unit that acquires stability state information for an image capturing apparatus indicating whether the image capturing apparatus is stable or not, and a processor that rotates an image, captured by the image capturing apparatus, based on the stability state information of the image capturing apparatus.

According to an embodiment of the present disclosure, there is provided a method for correcting an image, comprising: acquiring, in an acquiring unit, stability information for an image capturing apparatus indicating whether the image capturing apparatus is stable or not; and rotating, in a processor, an image captured by the image capturing apparatus, based on the stability information of the image capturing apparatus.

According to an embodiment of the present disclosure, there is provided a nontransitory computer-readable medium storing computer-readable instructions thereon, the computer-readable instructions when executed by a processor cause the processor to perform a method comprising: acquiring stability information for an image capturing apparatus indicating whether the image capturing apparatus is stable or not; and rotating an image captured by the image capturing apparatus, based on the stability information of the image capturing apparatus.

According to an embodiment of the present disclosure, there is provided an image processing system, comprising: an image capturing apparatus configured to capture an image, the image capturing apparatus including a micro-electro-mechanical-system (MEMS) acceleration sensor to determine a tilt thereof; and an image processing apparatus including a touch panel display configured to display the image captured by the image capturing apparatus and to receive a user input, an acquiring unit acquire stability state information for the image capturing apparatus indicating whether the image capturing apparatus is stable or not, and a processor configured to rotate the image, captured by the image capturing apparatus, based on the stability state information of the image capturing apparatus.

### Advantageous Effects of Invention

According to the above embodiments of the present disclosure, it is possible to provide a novel and improved image processing apparatus, image processing method, and computer program capable of correcting tilting of picked-up images in keeping with the state of a housing so that images in which tilting is corrected can be easily acquired.

### BRIEF DESCRIPTION OF DRAWINGS

FIG. 1 is a diagram useful in explaining an example of the external appearance of an image pickup apparatus 100 according to an embodiment of the present disclosure.

FIG. 2 is a diagram useful in explaining an example of the functional configuration of the image pickup apparatus 100 according to an embodiment of the present disclosure.

FIG. 3 is a diagram useful in explaining an example of the functional configuration of the image pickup apparatus 100 according to an embodiment of the present disclosure.

FIG. 4 is a diagram useful in explaining a method of detecting a displacement from a vertical state of the housing 101 of the image pickup apparatus 100 according to an embodiment of the present disclosure.

FIG. 5 is a diagram useful in explaining an example of tilting correction of picked-up images using the image pickup apparatus 100 according to an embodiment of the present disclosure.

FIG. 6 is a flowchart showing an example operation of the image pickup apparatus 100 according to an embodiment of the present disclosure.

FIG. 7 is a flowchart showing an example operation of the image pickup apparatus 100 according to an embodiment of the present disclosure.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

1. Embodiments of the Present Disclosure

Example of External Appearance of Image Pickup Apparatus

First Example of Functional Configuration of Image Pickup Apparatus Second

Example of Functional Configuration of Image Pickup Apparatus

Method of Detecting Displacement from Vertical State

Example Operation of Image Pickup Apparatus

2. Conclusion

1. Embodiments of the Present Disclosure

Example of External Appearance of Image Pickup Apparatus

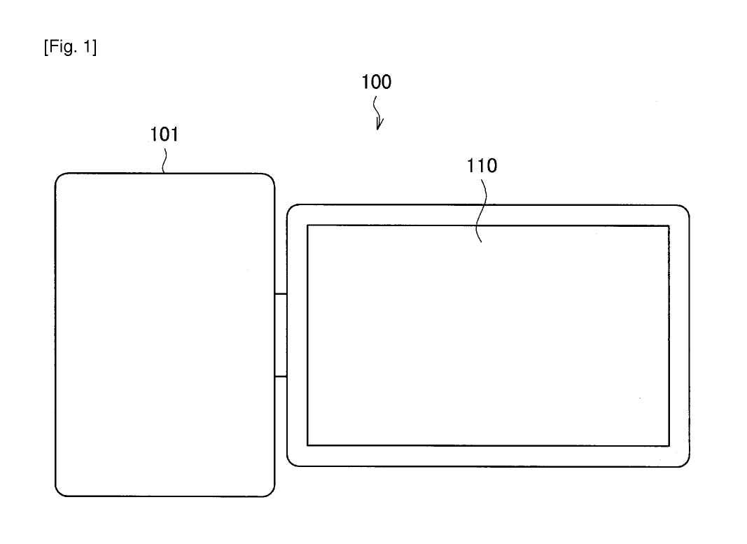

First, an example of an image pickup apparatus according to an embodiment of the present disclosure, which is also an example of an image processing apparatus according to an embodiment of the present disclosure, will be described with reference to the drawings. FIG. 1 is a diagram useful in explaining an example of the external appearance of an image pickup apparatus 100 according to an embodiment of the present disclosure. The image pickup apparatus 100 according to an embodiment of the present disclosure will be described with reference to FIG. 1.

FIG. 1 shows a state where the image pickup apparatus 100 is viewed from a rear side thereof. The image pickup apparatus 100 according to an embodiment of the present disclosure has the external appearance shown in FIG. 1, for example, and is an apparatus capable of picking up electronic images (still images or moving images) according to an operation by a photographer. The image pickup apparatus 100 according to an embodiment of the present disclosure has a function for correcting the tilting of picked-up images in accordance with the state of a housing 101. By including a function for correcting the tilting of picked-up images in accordance with the state of the housing 101, the image pickup apparatus 100 according to an embodiment of the present disclosure can enable the photographer to easily acquire images in which tilting is corrected.

The image pickup apparatus 100 according to an embodiment of the present disclosure is capable of displaying images being picked up or images that have previously been picked up on a display unit 110. The photographer view images displayed on the display unit 110 and can pick up images by holding the image pickup apparatus 100 or fixing the image pickup apparatus 100 to a tripod or the like so that images picked up by the image pickup apparatus 100 are horizontal. However, as described earlier, it is extremely time-consuming to carry out manual adjustments so that the images picked up by the image pickup apparatus 100 are horizontal, which increases the risk of photographic opportunities being missed.

For this reason, when picked-up images are tilted, the image pickup apparatus 100 according to an embodiment of the present disclosure carries out image processing to correct such tilting in accordance with the state of the housing 101. By carrying out image processing that corrects tilting in accordance with the state of the housing 101, as described above the image pickup apparatus 100 according to an embodiment of the present disclosure can enable the photographer to easily acquire images in which tilting is corrected.

When carrying out image pickup processing that records still images or moving images as files, the image pickup apparatus 100 according to an embodiment of the present disclosure acquires, as a state of the housing 101, a stable state of the housing 101 and a state that is displaced from a vertical state of the housing 101. On confirming that the housing 101 is in a stable state when carrying out the image pickup process, the image pickup apparatus 100 according to an embodiment of the present disclosure carries out image processing so as to cancel out the displacement from the vertical state of the housing 101. By acquiring, as the state of the housing 101, a stable state of the housing 101 and a state that is displaced from a vertical state of the housing 101, the image pickup apparatus 100 according to an embodiment of the present disclosure makes it possible to easily acquire picked-up images in which tilting is corrected.

Note that in the following description, as one example of a standard for carrying out image processing, it is determined whether to carry out image processing according to whether the housing 101 is in a stable state. As one example, it is possible to determine whether the housing 101 is in a stable state by determining whether the housing 101 is in a state with a specified acceleration or lower. In the following description, this state where the housing 101 has a specified acceleration or lower is referred to as the “stationary state” of the housing 101. That is, if the housing 101 of the image pickup apparatus 100 according to an embodiment of the present disclosure is in the stationary state, the housing 101 is in a stable state with a specified acceleration or lower, and since it is believed that the housing 101 will have been stably mounted on a tripod or the like, image processing that corrects tilting of the picked-up images is carried out. Also, in the following description, the state where the housing 101 is in the stationary state is referred to as “stationary mode on”, and a state where the housing 101 is not in the stationary state is referred to as “stationary mode off”.

This completes the description of the image pickup apparatus 100 that is an embodiment of the present disclosure with reference to FIG. 1. Next, an example of the functional configuration of the image pickup apparatus 100 according to an embodiment of the present disclosure will be described.

First Example of Functional Configuration of Image Pickup Apparatus

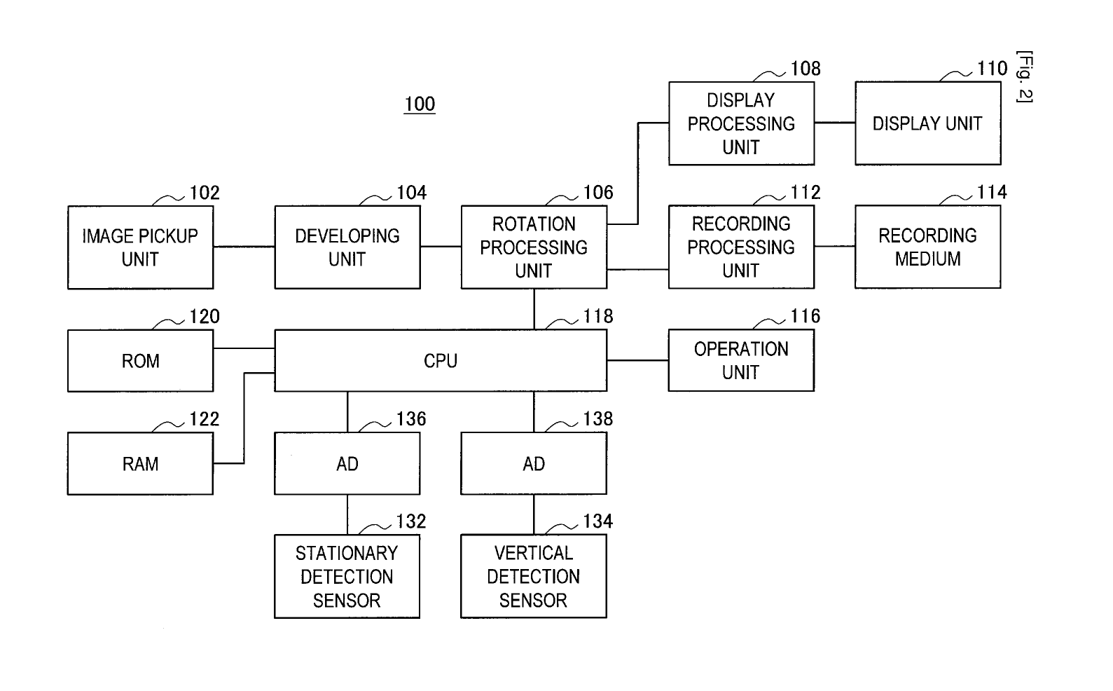

FIG. 2 is a diagram useful in explaining one example of the functional configuration of an image pickup apparatus 100 according to an embodiment of the present disclosure. An example of the functional configuration of the image pickup apparatus 100 according to an embodiment of the present disclosure will now be described with reference to FIG. 2.

As shown in FIG. 2, the image pickup apparatus 100 that is an embodiment of the present disclosure includes an image pickup unit 102, a developing unit 104, a rotation processing unit 106, a display processing unit 108, a display unit 110, a recording processing unit 112, a recording medium 114, an operation unit 116, a CPU 118, a ROM 120, a RAM 122, a stationary detection sensor 132, a vertical detection sensor 134, and AD converters 136, 138. The respective blocks of the image pickup apparatus 100 shown in FIG. 2 are provided on the surface of or inside the housing 101.

The image pickup unit 102 includes a lens, an imager including a solid-state image pickup element such as a CCD (Charge Coupled Device) or a CMOS (Complementary Metal Oxide Semiconductor), a timing generator that controls exposure timing and the like for the image sensor, a sample/hold circuit, and an interface unit for providing raw data of an image obtained by exposing the imager to downstream circuits, and the like. The raw data of an image obtained by the image pickup unit 102 is supplied to the developing unit 104.

The developing unit 104 carries out a developing process on the raw data of an image obtained by the image pickup unit 102. Here, as examples, the developing process carried out by the developing unit 104 is processing that generates YC data including a luminance signal and a color difference signal by interpolating image data of a Bayer pattern obtained by the image pickup unit 102 and/or carries out specified image processing, such as resolution conversion and/or edge enhancement, on the YC data. The data that has been subjected to the developing process by the developing unit 104 is supplied to the rotation processing unit 106.

The rotation processing unit 106 carries out processing that rotates the YC data supplied from the developing unit 104. Here, the rotation processing unit 106 carries out processing that rotates the YC data supplied from the developing unit 104 by a rotational angle indicated from the CPU 118 based on a rotation process instruction from the CPU 118. The rotation processing unit 106 carries out processing that rotates the YC data supplied from the developing unit 104 only when there has been a rotation process instruction from the CPU 118. The rotation processing unit 106 supplies the YC data to the display processing unit 108 and the recording processing unit 112 regardless of whether the rotation process has been carried out.

When carrying out a process that rotates the YC data supplied from the developing unit 104, the rotation processing unit 106 may for example use an affine transform that is a transformation in which parallel movement and a linear transform are combined. The rotation processing unit 106 may carry out the rotation process on both YC data for images for displaying a so-called “live view” where images obtained by the image pickup unit 102 are displayed in real time on the display unit 110 (described later) and on YC data for images for recording images obtained by the image pickup unit 102 on the recording medium 114, described later, or may carry out the rotation process on only one of such YC data.

The rotation processing unit 106 may record information on a rotation angle supplied from the CPU 118 on the recording medium 114 in synchronization with the image data obtained by the image pickup unit 102, for example, without carrying out a rotation process on such image data. By recording information on the rotation angle supplied from the CPU 118 on the recording medium 114 in synchronization with the image data, the rotation processing unit 106 is capable of carrying out the rotation process on the image data obtained by the image pickup unit 102 even after recording on the recording medium 114.

The display processing unit 108 converts the YC data supplied from the rotation processing unit 106 to a format set by the display unit 110 and supplies the data to the display unit 110. The display unit 110 displays images based on data supplied from the display processing unit 108. Note that aside from the images picked up by the image pickup unit 102, various setting information is also displayed on the display unit 110. The display unit 110 is constructed of a liquid crystal display panel or an organic EL panel, for example. Note that a touch panel may also be provided on a display screen of the display unit 110.

The recording processing unit 112 includes a file system such as a FAT (File Allocation Table). The recording processing unit 112 converts the YC data supplied from the rotation processing unit 106 to a recording format such as MPEG, and records on the recording medium 114 via the file system. Note that if information on the rotation angle is supplied from the rotation processing unit 106, the recording processing unit 112 records such information on the rotation angle on the recording medium 114 so as to be synchronized with the image data.

The recording medium 114 is a recording medium which for example is incorporated in the image pickup apparatus 100 or is removable from the image pickup apparatus 100 and as examples is constructed of a hard disk drive or a memory card incorporating a flash memory. The recording medium 114 is one example of a “state information storage unit” for the present disclosure and may store information on the displacement from the vertical state of the housing 101 detected by the vertical detection sensor 134, described later.

The operation unit 116 is constructed of various switches and buttons for operating the image pickup apparatus 100. The switches and buttons for operating the image pickup apparatus 100 include for example a power button, a shutter button, zoom buttons (or zoom keys), and buttons for making various settings. Note that if a touch panel is provided on the display screen of the display unit 110, such touch panel is also included in the operation unit 116.

The CPU 118 carries out various processing to control operations of the image pickup apparatus 100. By successively reading and executing computer programs stored in the ROM 120, for example, the CPU 118 controls the operations of the image pickup apparatus 100. In the present embodiment, the CPU 118 instructs the rotation processing unit 106 to carry out a rotation process of the YC data based on the data supplied from the stationary detection sensor 132 and/or the vertical detection sensor 134, described later. The CPU 118 calculates the stationary state of the housing 101 and/or tilting from the horizontal of the housing 101 based on the information from the stationary detection sensor 132 and/or the vertical detection sensor 134, described later. Accordingly, the CPU 118 serves as one example of a “state detecting unit” for the present disclosure.

The ROM 120 is a nonvolatile memory storing various computer programs that are necessary for the processing of the CPU 118 and various data. The RAM 122 is a volatile memory that is a work memory used during processing by the CPU 118.

The stationary detection sensor 132 is a sensor for detecting the stationary state of the housing 101 of the image pickup apparatus 100. As examples, the stationary detection sensor 132 is constructed of a gyrosensor with one to three axes or an acceleration sensor with one to three axes including a MEMS (MicroElectroMechanical System). Detection values of the stationary detection sensor 132 are subjected to A/D conversion by the AD converter 136 and are then supplied to the CPU 118 by serial communication or the like. The CPU 118 of the image pickup apparatus 100 according to one embodiment of the present disclosure may detect the stationary state of the housing 101 according to fluctuations on the time axis in the stationary state of the housing 101 detected by the stationary detection sensor 132.

The vertical detection sensor 134 is a sensor for detecting the displacement from the vertical state of the housing 101 of the image pickup apparatus 100. From the detection value of the vertical detection sensor 134, the CPU 118 is capable of deciding a rotation angle to be passed to the rotation processing unit 106. The vertical detection sensor 134 is constructed of MEMS acceleration sensors, for example. If the vertical detection sensor 134 is constructed of acceleration sensors, the acceleration sensors are provided in the horizontal direction and the vertical direction of a plane that is perpendicular to the optical axis of the image pickup apparatus 100. By being providing with the acceleration sensors in the horizontal direction and the vertical direction of a plane that is perpendicular to the optical axis of the image pickup apparatus 100, the vertical detection sensor 134 is capable of obtaining the extent of displacement from the vertical state of the housing 101 of the image pickup apparatus 100. After AD conversion of the detection values of the vertical detection sensor 134 by the AD converter 138, the detection values are supplied by serial communication or the like to the CPU 118.

If the stationary detection sensor 132 has detected that the image pickup apparatus 100 according to one embodiment of the present disclosure is in the stationary state, the image pickup apparatus 100 carries out image processing so as to correct the displacement from the vertical state detected by the vertical detection sensor 134. The image pickup apparatus 100 being in the stationary state is a state where the image pickup apparatus 100 is fixed using a tripod or the like, and the image pickup apparatus 100 being in the stationary state indicates a high probability that the user wants to pick up images in a state that is as close as possible to horizontal.

This completes the description of an example of the functional configuration of the image pickup apparatus 100 according to an embodiment of the present disclosure with reference to FIG. 2. Note that although FIG. 2 shows a configuration where the sensor for detecting the stationary state of the housing 101 of the image pickup apparatus 100 and the sensor for detecting the displacement from the vertical state of the housing 101 of the image pickup apparatus 100 are separate, the present disclosure is not limited to such configuration. The sensor for detecting the stationary state of the housing 101 of the image pickup apparatus 100 and the sensor for detecting the displacement from the vertical state of the housing 101 of the image pickup apparatus 100 may be collected into a single element.

Second Example of Functional Configuration of Image Pickup Apparatus

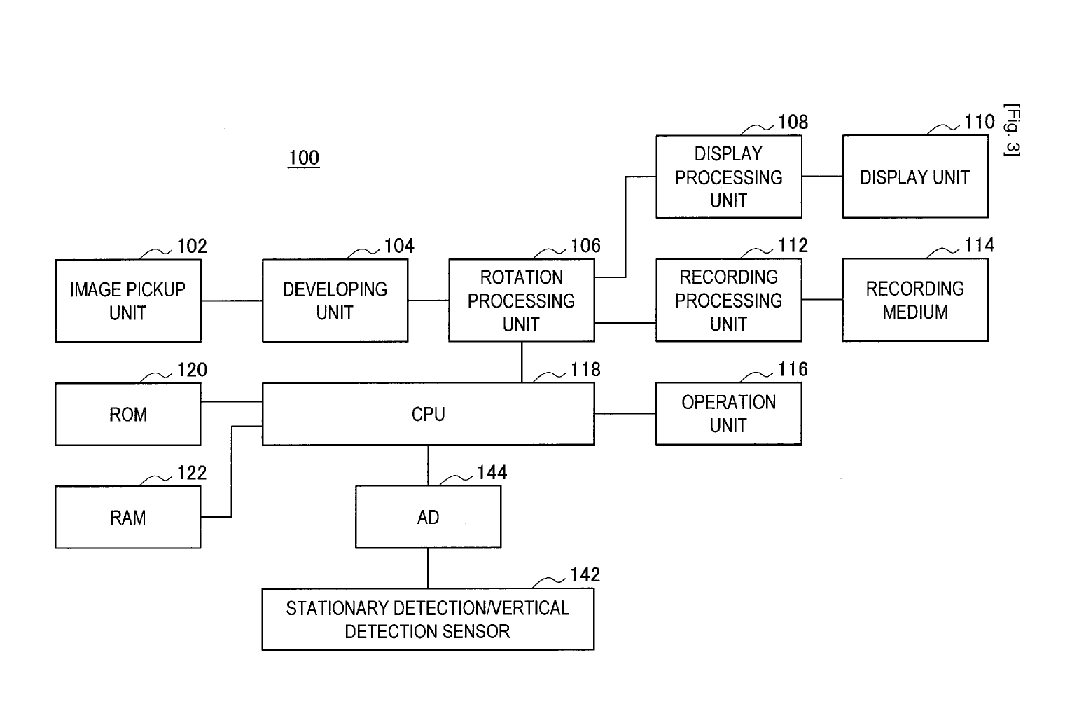

FIG. 3 is a diagram useful in explaining another example of the functional configuration of an image pickup apparatus 100 according to an embodiment of the present disclosure. Another example of the functional configuration of the image pickup apparatus 100 according to an embodiment of the present disclosure will now be described with reference to FIG. 3.

The image pickup apparatus 100 shown in FIG. 3 is equipped with a vertical detection/stationary detection sensor 142 in which the stationary detection sensor 132 and the vertical detection sensor 134 in the functional configuration of the image pickup apparatus 100 shown in FIG. 2 are combined into a single element. The vertical detection/stationary detection sensor 142 is a sensor for detecting the stationary state of the housing 101 of the image pickup apparatus 100 and the displacement from the vertical state of the housing 101 of the image pickup apparatus 100. The vertical detection/stationary detection sensor 142 is constructed by MEMS acceleration sensors, for example. After a detection value of the vertical detection/stationary detection sensor 142 has been subjected to AD conversion by the AD converter 144, such detection value is supplied by serial communication or the like to the CPU 118. From the state of the fluctuations in the value of the acceleration sensor, it is possible to detect the stationary state of the housing 101 of the image pickup apparatus 100. As one example, if there is little fluctuation in the value of the acceleration sensor, the CPU 118 can determine that the housing 101 of the image pickup apparatus 100 is in the stationary state.

This completes the description of the other example of the functional configuration of the image pickup apparatus 100 according to an embodiment of the present disclosure with reference to FIG. 3. Next, a method of detecting the displacement from the vertical state of the housing 101 of the image pickup apparatus 100 according to an embodiment of the present disclosure will be described.

Method of Detecting Displacement from Vertical State

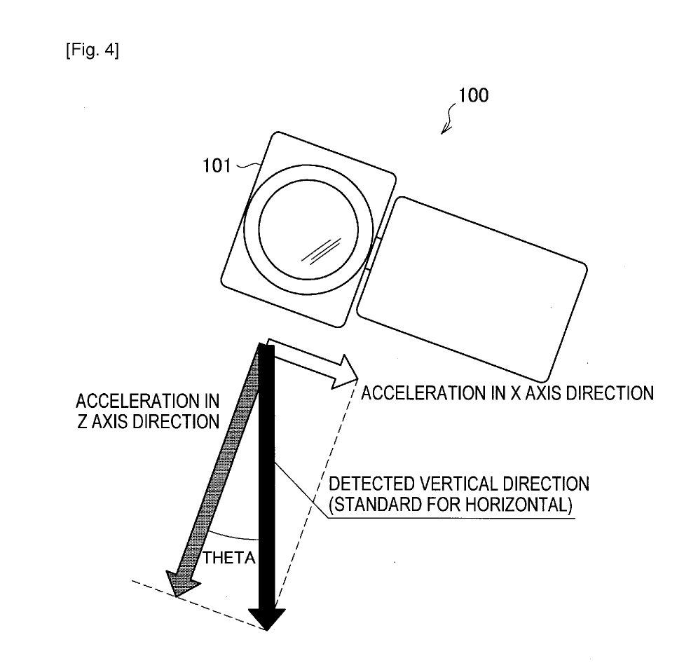

FIG. 4 is a diagram useful in explaining a method of detecting a displacement from the vertical state of the housing 101 of the image pickup apparatus 100 according to an embodiment of the present disclosure. In FIG. 4, it is assumed that the horizontal direction on a plane that is perpendicular to the optical axis of the image pickup apparatus 100 is the X axis and the vertical direction on such plane is the Z axis.

The image pickup apparatus 100 according to one embodiment of the present disclosure detects the angle of displacement theta from the vertical state of the housing 101 using the acceleration x in the X axis direction and the acceleration z in the Z axis direction. The angle of displacement theta from the vertical state of the housing 101 can be found using the acceleration x in the X axis direction and the acceleration z in the Z axis direction according to theta=atan2(z,x).

The CPU 118 finds the angle of displacement theta from the vertical state of the housing 101 according to the above equation and passes information on the angle of displacement theta to the rotation processing unit 106 as the rotation angle.

The rotation processing unit 106 carries out a rotation process on the YC data using notification from the CPU 118 that the housing 101 is in the stationary state and the rotation angle supplied from the CPU 118. If the housing 101 is in the stationary state, by carrying out a rotation process on the YC data using the rotation angle supplied from the CPU 118, the image pickup apparatus 100 according to an embodiment of the present disclosure will be capable of quickly carrying out tilting correction on the picked-up images so long as the housing 101 is in the stationary state.

This completes the description of a method of detecting the displacement from the vertical state of the housing 101 of the image pickup apparatus 100 according to an embodiment of the present disclosure. Next, an example of tilting correction of picked-up images using the image pickup apparatus 100 according to an embodiment of the present disclosure will be described.

Example of Tilting Correction of Picked-Up Images

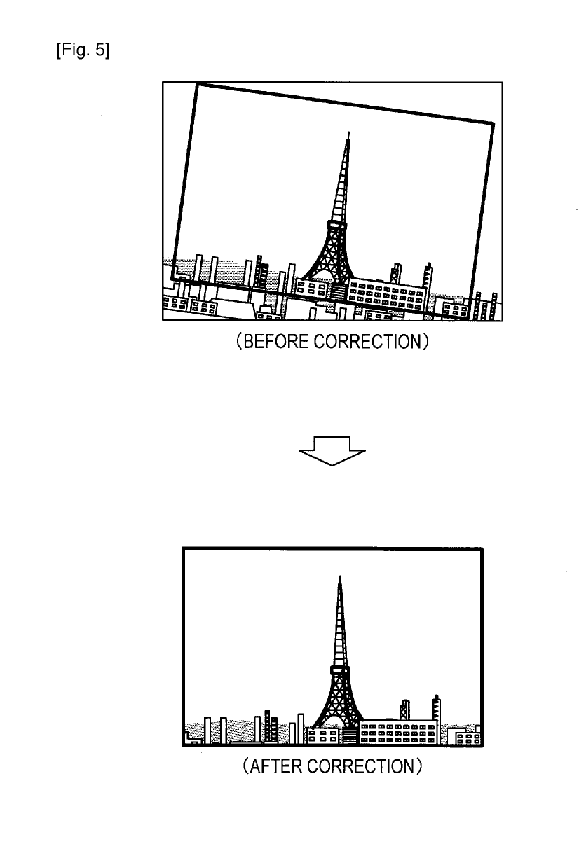

FIG. 5 is a diagram useful in explaining an example of tilting correction of picked-up images using the image pickup apparatus 100 according to an embodiment of the present disclosure. The top of FIG. 5 is an example of an image picked up by the image pickup unit 102 and the bottom of FIG. 5 is an example of an image produced by the rotation processing unit 106 correcting an image picked up by the image pickup unit 102.

In the present embodiment, the rotation processing unit 106 cuts out part of the image picked up by the image pickup unit 102 and rotates the cut-out part using the rotation angle supplied from the CPU 118. By doing so, the rotation processing unit 106 is capable of generating an image in which tilting is corrected.

Note that as shown in FIG. 5, although in this embodiment, the rotation processing unit 106 cuts out part of the image picked up by the image pickup unit 102 and rotates the cut-out part using the rotation angle supplied from the CPU 118, depending on the size of the cut-out part, there are cases where it is not possible to entirely correct the tilting using the rotation angle supplied from the CPU 118. A number of methods can conceivably be used in such case.

If the housing 101 is tilted with respect to the horizontal for picked-up images in excess of an angle for which tilting that can be corrected so that the images picked up by the image pickup unit 102 become horizontal, that is, if it is not possible to completely correct the tilting using the rotation angle supplied from the CPU 118, as one example the rotation processing unit 106 may generate a message indicating that the tilting is not capable of being corrected, or data that forms a base for such a message and output the generated message or data to the display processing unit 108. The display processing unit 108 may display a message indicating that the tilting is not capable of being corrected on the display unit 110, based on the message or data generated by the rotation processing unit 106.

If it is not possible to completely correct the tilting using the rotation angle supplied from the CPU 118, the rotation processing unit 106 may correct the tilting of the picked-up images within a range where correction is possible. When doing so, in addition to correcting the tilting of the picked-up images within a range where correction is possible, the rotation processing unit 106 may generate a message indicating that tilting is not capable of being completely corrected, or data that forms a base for such a message.

Note that the rotation processing unit 106 may correct the tilting of picked-up images only when the angle of displacement theta from the vertical state of the housing 101 is within a correctable range. Since the correctable range changes in accordance with the extent to which the images picked up by the image pickup unit 102 are cut out during the rotation process by the rotation processing unit 106, the determination of whether the angle of displacement theta from the vertical state of the housing 101 is within the correctable range will change in accordance with settings made for the rotation process.

This completes the description of an example of tilting correction for picked-up images using the image pickup apparatus 100 according to an embodiment of the present disclosure. Next, an example operation of the image pickup apparatus 100 according to an embodiment of the present disclosure will be described.

Example Operation of Image Pickup Apparatus

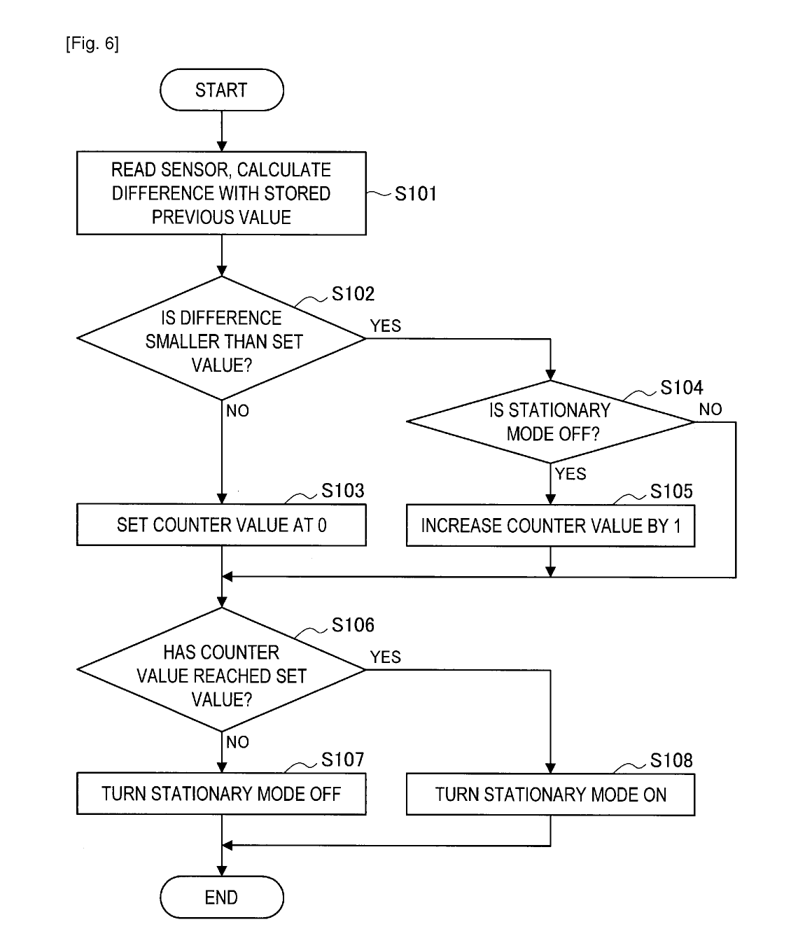

FIG. 6 is a flowchart showing an example operation of the image pickup apparatus 100 according to an embodiment of the present disclosure. The flowchart shown in FIG. 6 is a flowchart showing the processing that detects whether the housing 101 of the image pickup apparatus 100 is in a stationary state, that is, processing that determines whether the stationary mode of the image pickup apparatus 100 is on or off. Unless specifically indicated otherwise, the processing shown in FIG. 6 will be described as being executed by the CPU 118. Note that in an initial state, the stationary mode of the image pickup apparatus 100 is off.

To detect whether the housing 101 is in the stationary state, the CPU 118 reads the value acquired by the stationary detection sensor 132 in FIG. 2 or the vertical detection/stationary detection sensor 142 in FIG. 3 at specified intervals and stores such value in the RAM 122. In addition, the CPU 118 calculates the difference between the most recently read value and the previously read value (step S101). If the stationary detection sensor 132 in FIG. 2 or the vertical detection/stationary detection sensor 142 in FIG. 3 is an acceleration sensor, the CPU 118 reads the acceleration value, stores the value in the RAM 122, and calculates the difference in the acceleration values.

Once the difference between the most recently read value and the previously read value has been calculated in step S 101, the CPU 118 then determines whether the difference in values is smaller than a set value (step S 102).

If, as a result of the determination in step S102, the difference between the most recently read value and the previously read value is larger than the set value, the CPU 118 resets a counter for detecting whether the housing 101 is in the stationary state to zero (step S103).

Meanwhile, if, as a result of the determination in step S102, the difference between the most recently read value and the previously read value is equal to or smaller than the set value, the CPU 118 determines whether the stationary state of the image pickup apparatus 100 is off (step S104).

If, as a result of the determination in step S 104, the stationary mode of the image pickup apparatus 100 is off, the CPU 118 adds one to the value of the counter for detecting whether the housing 101 is in the stationary state (step S105). Meanwhile, if, as a result of the determination in step S 104, the stationary mode of the image pickup apparatus 100 is on, the CPU 118 skips the processing in step S 105.

Once the value of the counter has been set in step S103 or step S105 described above, the CPU 118 then determines whether the value of the counter has reached a set value (step S106).

If, as a result of the determination in step S106 described above, the value of the counter has not reached the set value, the CPU 118 determines that the stationary mode of the image pickup apparatus 100 is off (step S 107). Meanwhile, if, as a result of the determination in step S106 described above, the value of the counter has reached the set value, the CPU 118 determines that the stationary mode of the image pickup apparatus 100 is on (step S108).

In this way, the CPU 118 reads the value acquired by the stationary detection sensor 132 in FIG. 2 or the vertical detection/stationary detection sensor 142 in FIG. 3 at specified intervals and decides whether the image pickup apparatus 100 is in the stationary mode according to whether the difference between the most recently read value and the previously read value is smaller than the set value and whether the value of a counter has reached a set value (that is, whether the state where the difference is smaller than the set value has continued for a specified time). If the stationary mode of the image pickup apparatus 100 is on, the CPU 118 then instructs the rotation processing unit 106 to carry out tilting correction of the picked-up images.

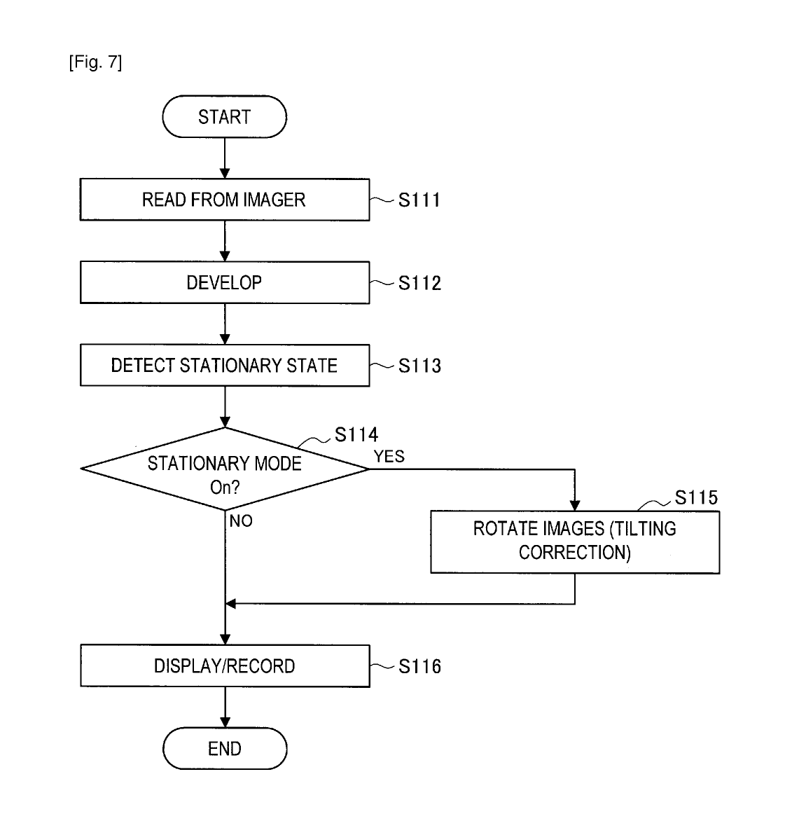

FIG. 7 is a flowchart showing an example operation of the image pickup apparatus 100 according to an embodiment of the present disclosure. The flowchart in FIG. 7 shows the operation of the image pickup apparatus 100 when carrying out a rotation process on the picked-up images. An example operation of the image pickup apparatus 100 according to an embodiment of the present disclosure will now be described with reference to FIG. 7.

In the image pickup apparatus 100, a read of data from the imager of the image pickup unit 102 is carried out according to control by the CPU 118 for example (step S111) and a developing process is carried out on the data read from the imager of the image pickup unit 102 by the developing unit 104 (step S 112).

Next, in the image pickup apparatus 100, detection of the stationary state of the housing 101 is carried out by the CPU 118 (step S 113). As described earlier, detection of the stationary state of the housing 101 is carried out by processing such as that shown in FIG. 6.

After this, as a result of the CPU 118 detecting the stationary state of the housing 101, the CPU 118 determines whether the stationary state of the image pickup apparatus 100 is on (step S 114).

If, as a result of the determination in step 5114 described above, the stationary mode is on, the CPU 118 instructs the rotation processing unit 106 to carry out the rotation process on the YC data obtained by the developing process in step 5112 described above. Based on the instruction from the CPU 118, the rotation processing unit 106 carries out the rotation process on the YC data obtained by the developing process in step S112 described above to correct the tilting of the picked-up images (step S 115). The rotation angle used in the rotation process in step S115 is the angle of displacement theta from the vertical state of the housing 101 found by the CPU 118. That is, the rotation processing unit 106 carries out a rotation process on the YC data that cancels out such angle of displacement theta.

Meanwhile, if, as a result of the determination in step 5114 described above, the stationary mode is off, the CPU 118 does not instruct the rotation processing unit 106 to carry out the rotation process. Accordingly, if the stationary mode is off, even if the YC data obtained by the developing process in step S112 described above is tilted from the horizontal, the rotation processing unit 106 will not change the YC data.

The image pickup apparatus 100 then displays the image data for which tilting correction has or has not been carried out on the display unit 110 and/or records such image data on the recording medium 114 (step S116).

By carrying out processing such as that described above, the image pickup apparatus 100 according to an embodiment of the present disclosure detects the stationary state of the housing 101 and, if the housing 101 is in the stationary state (that is, if the stationary mode is on), is capable of carrying out a rotation process on the picked-up images so as to cancel out the angle of displacement theta from the vertical state of the housing 101. By carrying out the processing described above, the image pickup apparatus 100 is capable of easily acquiring images in which tilting is corrected.

Note that although a case where the stationary state of the housing 101 is detected and a rotation process is carried out on picked-up images so as to cancel out the angle of displacement theta from the vertical state of the housing 101 if the housing 101 is in the stationary state (i.e., if the stationary mode is on), there are also cases where the photographer deliberately tilts the housing 101 by a certain extent to pick up images. In such case, automatic correction of tilting would conversely be problematic.

Accordingly, as one example it would be possible to enable the photographer to clearly set whether the tilting correction function is active or inactive. For example, if the photographer has set the tilting correction function at active by operating the operation unit 116, the CPU 118 instructs the rotation processing unit 106 to carry out the rotation process, but if the photographer has set the tilting correction function at inactive by operating the operation unit 116, the CPU 118 does not instruct the rotation processing unit 106 to carry out the rotation process.

In this way, by having the photographer clearly set whether the tilting correction function is active or inactive, the CPU 118 can determine whether the photographer is deliberately tilting the housing 101 by a certain extent to take pick up images.

Also, although a case where the tilting of picked-up images is corrected by a rotation process is described in the description given above, the present disclosure is not limited to such example. As one example, tilting of picked-up images may be corrected by a coordinate transform that does not depend on rotation.

2. Conclusion

As described above, the image pickup apparatus 100 according to an embodiment of the present disclosure carries out image processing that corrects tilting of picked-up images so as to cancel out an angle of displacement theta from the vertical state of the housing 101. When correcting tilting, the image pickup apparatus 100 according to an embodiment of the present disclosure detects a stationary state of the housing 101 and if the housing 101 is in the stationary state (i.e., if the stationary mode is on), determines that the housing 101 is fixed to a tripod or the like and carries out image processing that corrects tilting.

If the photographer has fixed the housing 101 to a tripod or the like, the image pickup apparatus 100 according to an embodiment of the present disclosure is capable of quickly calculating the angle of displacement theta from the vertical state of the housing 101 and carrying out image processing that corrects the tilting of picked-up images so as to cancel out the angle of displacement theta.

Note that although the image pickup apparatus 100 has been illustrated in the present embodiment as one example of an image processing apparatus according to an embodiment of the present disclosure, an “image processing apparatus” for the present disclosure is not limited to an image pickup apparatus. The technology according to the embodiments of the present disclosure can be applied in the same way to any apparatus capable of picking up images, such as a personal computer, a tablet terminal, a mobile phone, a smartphone, a mobile music player, and a portable television receiver.

Steps of processing executed by each section in the specification do not necessarily have to be performed in time-series in the order of steps described in a sequence diagram or each flowchart. For example, the steps of the processing executed by each section may be performed in the order different from that described in the flowchart or performed in parallel.

In addition, it is possible to generate computer programs for causing hardware such as a CPU, a ROM, or a RAM built in the corresponding section to exert functions equivalent to those in the configuration of the aforementioned sections. It is also possible to provide a recording medium in which the computer programs are stored. Moreover, configuring each functional block illustrated in the functional block diagram by hardware makes it possible to implement a series of processes of the functional block by hardware.

Although preferred embodiments of the present disclosure are described in detail above with reference to the appended drawings, the technical scope of the disclosure is not limited thereto. It should be understood by those skilled in the art that various modifications, combinations, sub-combinations and alterations may occur depending on design requirements and other factors insofar as they are within the scope of the appended claims or the equivalents thereof.

As one example, although a case where the stationary detection sensor 132 that is constructed of an acceleration sensor or the like is used to determine whether the image pickup apparatus 100 is in the stationary state is described in the above embodiment, the present disclosure is not limited to such example. For example, the image pickup apparatus 100 may be equipped with a sensor capable of detecting whether the image pickup apparatus 100 is fixed to a tripod and the stationary state of the image pickup apparatus 100 may be determined by detecting whether the image pickup apparatus 100 is fixed to a tripod. As one example, infrared light or the like may be emitted from the bottom of the housing 101 of the image pickup apparatus 100 and by detecting infrared light reflected by the camera platform of a tripod using a sensor or the like at the bottom of the housing 101 of the image pickup apparatus 100, fixing of the image pickup apparatus 100 to the tripod may be detected.

As another example, although a configuration where both the image pickup unit 102 that picks up images and the rotation processing unit 106 that corrects tilting by rotating the picked-up images are included inside the housing 101 of the image pickup apparatus 100 has been described, the present disclosure is not limited to this example configuration. A configuration that detects the stationary state of the housing 101 that includes the image pickup unit 102 and a configuration that detects tilting of the image pickup unit 102 to the horizontal in images picked up by the image pickup unit 102 may be a separate apparatus to a configuration that corrects tilting by rotating the picked-up images.

Additionally, the present technology may also be configured as below.

(1) An image processing apparatus, comprising: an acquiring unit to acquire stability state information for an image capturing apparatus indicating whether the image capturing apparatus is stable or not; and a processor configured to rotate an image, captured by the image capturing apparatus, based on the stability state information of the image capturing apparatus.

(2) The image processing apparatus of (1), wherein the processor rotates the image when the stability state information indicates that the image capturing device is stable.

(3) The image processing apparatus of any one of (1) to (2), wherein the acquiring unit further detects a tilt in a housing of the image capturing apparatus with respect to a horizontal axis of the image.

(4) The image processing apparatus according of (3), wherein the processor corrects a tilt in the image based on the tilt in the housing detected by the acquiring unit.

(5) The image processing apparatus of any of (1) to (4), wherein the acquiring unit detects the stability state of the image capturing apparatus by comparing a position change value to a predetermined threshold.

(6) The image processing apparatus of any one of (1) to (5), wherein the image capturing apparatus includes a position sensor configured to detect a position of a housing of the image capturing apparatus, a counter configured to measure a predetermined time interval, and an electronic memory configured to store position values detected by the position sensor, and wherein the acquiring unit detects the stability state of the image capturing apparatus based on the position change value generated as a difference between a previously stored position value and a current position value detected by the position sensor.

(7) The image processing apparatus of (6), wherein the stability state is determined when position change values remain below the predetermined threshold for a duration of the time interval measured by the counter.

(8) The image processing apparatus of any of (4) to (7), wherein the acquiring unit detects the tilt in the housing of the image capturing apparatus as a tilt angle, and the processor corrects the tilt in the image by rotating the image by the tilt angle so that the image is in a horizontal position.

(9) The image processing apparatus of any of (1) to (8), further comprising: a user interface configured to receive a user input to activate or deactivate image tilt correction, wherein the processor corrects the image when tilt correction is active and does not correct the image when tilt rotation is deactivated.

(10) The image processing apparatus of any of (4) to (9), wherein the processor corrects the tilt in an image currently being captured and displayed on the image capturing apparatus.

(11) The image processing apparatus of any of (4) to (10), wherein the processor determines whether the tilt in the image can be corrected, corrects the tilt in the image when the tilt can be corrected, and does not correct the tilt in the image when the tilt cannot be corrected.

(12) The image processing apparatus of (11), wherein the processor generates a message indicating that the tilt in the image cannot be corrected when the tilt in the image cannot be corrected.

(13) The image processing apparatus of any of (4) to (10), wherein the processor determines whether the tilt in the image can be fully corrected, and partially corrects the tilt in the image when the tilt in the image can only be partially corrected.

(14) The image processing apparatus of (13), wherein the processor generates a message indicating that the tilt in the image is partially corrected when the tilt in the image cannot be fully corrected.

(15) The image processing apparatus of any of (13) to (14), wherein the processor determines whether the tilt in the image can be corrected based on a cropping of the image.

(16) The image processing apparatus of any of (1) to (15), wherein the image capture apparatus includes a tripod sensor configured to determine whether the image capture apparatus is attached to a tripod, and the acquiring unit determines the stability state of the image capture apparatus based on information received from the tripod sensor.

(17) The image processing apparatus of (16), wherein the acquiring unit indicates that the image capturing apparatus is in a stable state when the information from the tripod sensor indicates that the image capturing apparatus is attached to a tripod.

(18) A method for correcting an image, comprising: acquiring, in an acquiring unit, stability information for an image capturing apparatus indicating whether the image capturing apparatus is stable or not; and rotating, in a processor, an image captured by the image capturing apparatus, based on the stability information of the image capturing apparatus.

(19) A non-transitory computer-readable medium storing computer-readable instructions thereon, the computer-readable instructions when executed by a processor cause the processor to perform a method comprising: acquiring stability information for an image capturing apparatus indicating whether the image capturing apparatus is stable or not; and rotating an image captured by the image capturing apparatus, based on the stability information of the image capturing apparatus.

(20) An image processing system, comprising: an image capturing apparatus configured to capture an image, the image capturing apparatus including a microelectro-mechanical-system (MEMS) acceleration sensor to determine a tilt thereof; and an image processing apparatus including a touch panel display configured to display the image captured by the image capturing apparatus and to receive a user input, an acquiring unit acquire stability state information for the image capturing apparatus indicating whether the image capturing apparatus is stable or not, and a processor configured to rotate the image, captured by the image capturing apparatus, based on the stability state information of the image capturing apparatus.

(21) An image processing apparatus including:

a state detecting unit detecting a stable state of a housing equipped with an image pickup unit picking up an image; and

an image correcting unit correcting tilting of the image picked up by the image pickup unit in accordance with a result obtained by the state detecting unit detecting the stable state.

(22) The image processing apparatus according to (21),

wherein the image correcting unit automatically corrects tilting of the image picked up by the image pickup unit in accordance with the stable state of the housing detected by the state detecting unit.

(23) The image processing apparatus according to (21) or (22),

wherein the state detecting unit detects tilting of the housing with respect to a horizontal direction in the image picked up by the image pickup unit, and wherein the image correcting unit corrects tilting of the image picked up by the image pickup unit by rotating the image in accordance with the result obtained by the state detecting unit detecting the stable state.

(24) The image processing apparatus according to (23),

wherein the image correcting unit corrects the tilting by rotating the image picked up by the image pickup unit in a manner that the image becomes horizontal.

(25) The image processing apparatus according to (23),

wherein the image correcting unit is not operable, when the state detecting unit detects that the housing is tilted in excess of an angle at which tilting is capable of being corrected in a manner that the image picked up by the image pickup unit becomes horizontal, to correct the image picked up by the image pickup unit.

(26) The image processing apparatus according to (23),

wherein the image correcting unit is operable, when the state detecting unit detects that the housing is tilted in excess of an angle at which tilting is capable of being corrected in a matter that the image picked up by the image pickup unit becomes horizontal, to correct the image within a possible range.

(27) The image processing apparatus according to (23),

wherein the image correcting unit corrects the tilting of the image picked up by the image pickup unit by rotating the image according to an affine transform.

(28) The image processing apparatus according to any one of (23) to (27),

wherein the image correcting unit corrects the tilting of the image picked up by the image pickup unit only if the tilting of the housing detected by the state detecting unit is within a specified range.

(29) The image processing apparatus according to any one of (23) to (28),

wherein the image correcting unit is operable, when the tilting of the housing detected by the state detecting unit exceeds a correctable range, to generate a message. (30) The image processing apparatus according to any one of (23) to (29), further including:

a sensor unit acquiring a state of tilting of the housing,

wherein the state detecting unit detects the state of the housing according to a fluctuation on a time axis in the state of the housing acquired by the sensor unit.

(31) The image processing apparatus according to any one of (21) to (30), further including:

a state information storage unit storing information relating to the stable state of the housing detected by the state detecting unit,

wherein the image correcting unit corrects tilting of the image picked up by the image pickup unit in accordance with the stable state of the housing using the information stored in the state information storage unit.

(32) The image processing apparatus according to any one of (21) to (31),

wherein the image correcting unit corrects tilting of a moving image picked up by the image pickup unit.

(33) The image processing apparatus according to any one of (21) to (31),

wherein the image correcting unit corrects tilting of a still image picked up by the image pickup unit.

(34) The image processing apparatus according to any one of (21) to (33),

wherein the image correcting unit corrects tilting of the image picked up by the image pickup unit in accordance with the result obtained by the state detecting unit detecting the stable state, based on a user operation.

(35) The image processing apparatus according to any one of (21) to (34),

wherein the state detecting unit detects a stationary state of the housing as the stable state.

(36) An image processing method including:

detecting a stable state of a housing equipped with an image pickup unit picking up an image; and

correcting tilting of the image picked up by the image pickup unit in accordance with a result obtained in the state detecting step.

(37) A computer program for causing a computer to execute:

detecting a stable state of a housing equipped with an image pickup unit picking up image; and

correcting tilting of the image picked up by the image pickup unit in accordance with a result obtained in the state detecting step.

### REFERENCE SIGNS LIST

100 Image pickup apparatus
101 Housing
102 Image pickup unit
104 Developing unit
106 Rotation processing unit
108 Display processing unit
110 Display unit
112 Recording processing unit
114 Recording medium
116 Operation unit
118 CPU
120 ROM
122 RAM
132 Stationary detection sensor
134 Vertical detection sensor
136, 138 AD converter

1. An image processing apparatus, comprising:
an acquiring unit to acquire stability state information for an image capturing apparatus indicating whether the image capturing apparatus is stable or not; and
a processor configured to rotate an image, captured by the image capturing apparatus, based on the stability state information of the image capturing apparatus.

2. The image processing apparatus according to claim 1, wherein the processor rotates the image when the stability state information indicates that the image capturing device is stable.

3. The image processing apparatus according to claim 1, wherein the acquiring unit further detects a tilt in a housing of the image capturing apparatus with respect to a horizontal axis of the image.

4. The image processing apparatus according to claim 3, wherein the processor corrects a tilt in the image based on the tilt in the housing detected by the acquiring unit.

5. The image processing apparatus according to claim 1, wherein the acquiring unit detects the stability state of the image capturing apparatus by comparing a position change value to a predetermined threshold.

6. The image processing apparatus according to claim 5, wherein the image capturing apparatus includes a position sensor configured to detect a position of a housing of the image capturing apparatus, a counter configured to measure a predetermined time interval, and an electronic memory configured to store position values detected by the position sensor, and
wherein the acquiring unit detects the stability state of the image capturing apparatus based on the position change value generated as a difference between a previously stored position value and a current position value detected by the position sensor.

7. The image processing apparatus according to claim 6, wherein the stability state is determined when position change values remain below the predetermined threshold for a duration of the time interval measured by the counter.

8. The image processing apparatus according to claim 4, wherein the acquiring unit detects the tilt in the housing of the image capturing apparatus as a tilt angle, and the processor corrects the tilt in the image by rotating the image by the tilt angle so that the image is in a horizontal position.

9. The image processing apparatus according to claim 1, further comprising:
a user interface configured to receive a user input to activate or deactivate image tilt correction,
wherein the processor corrects the image when tilt correction is active and does not correct the image when tilt rotation is deactivated.

10. The image processing apparatus according to claim 8, wherein the processor corrects the tilt in an image currently being captured and displayed on the image capturing apparatus.

11. The image processing apparatus according to claim 4, wherein the processor determines whether the tilt in the image can be corrected, corrects the tilt in the image when the tilt can be corrected, and does not correct the tilt in the image when the tilt cannot be corrected.

12. The image processing apparatus according to claim 11, wherein the processor generates a message indicating that the tilt in the image cannot be corrected when the tilt in the image cannot be corrected.

13. The image processing apparatus according to claim 4, wherein the processor determines whether the tilt in the image can be fully corrected, and partially corrects the tilt in the image when the tilt in the image can only be partially corrected.

14. The image processing apparatus according to claim 13, wherein the processor generates a message indicating that the tilt in the image is partially corrected when the tilt in the image cannot be fully corrected.

15. The image processing apparatus according to claim 13, wherein the processor determines whether the tilt in the image can be corrected based on a cropping of the image.

16. The image processing apparatus according to claim 1, wherein the image capture apparatus includes a tripod sensor configured to determine whether the image capture apparatus is attached to a tripod, and
the acquiring unit determines the stability state of the image capture apparatus based on information received from the tripod sensor.

17. The image processing apparatus according to claim 16, wherein the acquiring unit indicates that the image capturing apparatus is in a stable state when the information from the tripod sensor indicates that the image capturing apparatus is attached to a tripod.

18. A method for correcting an image, comprising:
acquiring, in an acquiring unit, stability information for an image capturing apparatus indicating whether the image capturing apparatus is stable or not; and
rotating, in a processor, an image captured by the image capturing apparatus, based on the stability information of the image capturing apparatus.

19. A non-transitory computer-readable medium storing computer-readable instructions thereon, the computer-readable instructions when executed by a processor cause the processor to perform a method comprising:
acquiring stability information for an image capturing apparatus indicating whether the image capturing apparatus is stable or not; and
rotating an image captured by the image capturing apparatus, based on the stability information of the image capturing apparatus.

20. An image processing system, comprising:
an image capturing apparatus configured to capture an image, the image capturing apparatus including a microelectro-mechanical-system (MEMS) acceleration sensor to determine a tilt thereof; and
an image processing apparatus including
a touch panel display configured to display the image captured by the image capturing apparatus and to receive a user input,
an acquiring unit acquire stability state information for the image capturing apparatus indicating whether the image capturing apparatus is stable or not, and
a processor configured to rotate the image, captured by the image capturing apparatus, based on the stability state information of the image capturing apparatus.
